(19) United States
(12) Patent Application Publication
(10) Pub. No.: US 2012/0156648 A1
(43) Pub. Date: Jun. 21, 2012

(54) APPARATUS AND METHOD FOR DELIVERING A THERAPEUTIC AGENT TO DENTAL TISSUE

(75) Inventors: MICHAEL KAUFMAN, BEACHWOOD, OH (US); ALAN T. RIGA, MAYFIELD HEIGHTS, OH (US)

(73) Assignee: BUCKEYE DENTAL, LLC, BEACHWOOD, OH (US)

(21) Appl. No.: 13/315,930

(22) Filed: Dec. 9, 2011

Related U.S. Application Data
(60) Provisional application No. 61/424,980, filed on Dec. 20, 2010.

(51) Int. Cl. A61C 19/06

(52) U.S. Cl. 433/215; 433/32

(57) ABSTRACT

An apparatus for delivering at least one therapeutic agent to a dental tissue of a subject includes at least one electrode, a medicament layer including at least one therapeutic agent, an electrical signal source, and logic configured to control the electrical signal source. At least one electrode has oppositely disposed, dental mouthpiece-shaped first and second major surfaces. The first major surface is curved such that the first major surface substantially conforms to the contour of the dental tissue when placed in contact with the dental tissue. The medicament layer is disposed on at least a portion of the second major surface. The electrical signal source provides a signal having certain characteristics and is electrically connected to at least one electrode. The certain characteristics comprise at least one orienting frequency and at least one motivating frequency sufficient to motivate at least one therapeutic agent into the dental tissue.

This application claims priority to U.S. Ser. No. 61/424,980, entitled APPARATUS AND METHOD FOR DELIVERING A THERAPEUTIC AGENT TO DENTAL TISSUE, filed Dec. 20, 2010, which is incorporated herein by reference.

### TECHNICAL FIELD

The present invention relates generally to an apparatus and method for delivering a therapeutic agent to dental tissue, and more particularly to a dielectrophoretic apparatus and related method for delivering at least one therapeutic agent to a dental tissue of a subject.

### BACKGROUND OF THE INVENTION

The treatment of dental diseases in mammals, including humans and non-humans alike often requires that drugs or other agents be delivered to the gums, teeth, or mouth tissue in a therapeutic dose. Such diseases may occur in the gums, teeth, tongue, lips, or jaw, as well as other dental structures. One treatment methodology is to deliver a dental agent to these structures via local drug administration, as opposed to systemic drug administration. This permits agents to be delivered directly to a site requiring evaluation and/or therapy. Because of drug localization, there is less of a concern for release or dissemination of the drug beyond the site of delivery. Such is also the case for other body sites where it is desirable to limit drug dissemination or systemic administration, yet still provide drugs in various formulations.

In many instances, however, local drug administration to the area of the mouth is not easily accomplished. Thus, localized drug administration often requires painful, difficult or invasive procedures to gain access to the various dental structures being treated. This may entail inserting a conduit, such as a fine gauge needle into the mouth tissue, or forming an incision for positioning of a device, such as a drug depot. Consequently, such treatment typically requires a visit to a hospital or doctor's office or dentist's office, or oral surgeon's office where trained health care professionals can perform the necessary, relatively more invasive procedures to achieve local drug administration.

Except for the route of intravenous administration, after dissolution, a drug must traverse several semi permeable biologic barriers before reaching the systemic circulation. A drug may cross the biologic barrier by passive diffusion, or by other naturally occurring transfer modes, for example, facilitated passive diffusion, active transport, or pinocytosis. Alternatively, a drug may be artificially assisted to cross the biologic barrier.

In passive diffusion, transport depends on the concentration gradient of the solute across the biologic barriers. Since the drug molecules are rapidly removed by the systemic circulation, drug concentration in the blood is low compared with that at the administration site, producing a large concentration gradient. The drug diffusion rate is directly proportional to that gradient. Yet, the drug diffusion rate also depends on other parameters, for example, the molecule's lipid solubility and size. Because cell membranes are lipoid, lipid-soluble drugs diffuse more rapidly through cell membranes than relatively lipid-insoluble drugs. Additionally, small drug molecules penetrate biologic barriers more rapidly than large ones.

Another naturally occurring transfer mode is facilitated passive diffusion, which occurs for certain molecules, such as glucose. It is believed that a carrier component combines reversibly with a substrate molecule at the cell membrane exterior. The carrier-substrate complex diffuses rapidly across the membrane, releasing the substrate at the interior surface. This process is characterized by selectivity and saturability. The carrier is operative only for substrates with a relatively specific molecular configuration, and the process is limited by the availability of carriers.

An alternative is nanotechnology, which derives its name from the size of the objects that it deals with. These are objects that are usually smaller than 100 nanometers, and may be at the molecular scale. As related to pharmaceuticals, the drugs particles are reduced to “nano” size, for smoother release, better dissolution pattern, better control on absorption, and decreasing the required dose.

Active transport, which is another naturally occurring transfer mode, appears to be limited to drugs that are structurally similar to endogenous substances. Active transport is characterized by selectivity and saturability and requires energy expenditure by the cell. It has been identified for various ions, vitamins, sugars, and amino acids.

Still another naturally occurring transfer mode is pinocytosis, in which fluids or particles are engulfed by a cell. The cell membrane encloses the fluid or particles, then fuses again, forming a vesicle that later detaches and moves to the cell interior. Like active transport, this mechanism requires energy expenditure. It is known to play a role in drug transport of protein drugs.

The foregoing discussion relates to naturally occurring transfer modes. Where these are insufficient, for example, in cases of macromolecules and polar compounds, which cannot effectively traverse the biological barrier, drug transport may be artificially induced.

Electrotransport refers generally to electrically induced passage of a drug (or a drug precursor) through a biological barrier. Several electrotransport mechanisms are known, as follows:

A localized drug delivery may be accomplished using iontophoresis. Although iontophoresis is generally well-accepted by patients and medical professionals, there are some risks involved. For example, high current intensity or long treatment times can lead to pain, burning sensations, skin irritation, erythema, blister formation, and skin necrosis. In the most extreme cases, high currents produced by direct current iontophoresis can short-circuit through a patient's heart. Iontophoresis also requires reformulated compounds for application and, thus, cannot typically be used with market-available drugs.

Electroosmosis involves the movement of a solvent with the agent through a membrane under the influence of an electric field.

Electrophoresis is based on migration of charged species in an electromagnetic field. Ions, molecules, and particles with charge carry current in solutions when an electromagnetic field is imposed. Movement of a charged species tends to be toward the electrode of opposite charge. The voltages for continuous electrophoresis are rather high (several hundred volts).

Electroporation is the process in which a biological barrier is subjected to a high voltage alternating-current (AC) surge, or pulse. The AC pulse creates temporary pores in the biological membrane, specifically between cells. The pores allow large molecules, such as proteins, DNA, RNA, and plasmids to pass through the biological barrier.

Iontophoresis, electroosmosis, and electrophoresis are diffusion processes, in which diffusion is enhanced by electrical or electromagnetic driving forces. In contrast, electroporation literally punctures the biological barriers, along cell boundaries, enabling passage of large molecules, through.

Generally a combination of more than one of these processes is at work, together with passive diffusion and other naturally occurring transfer modes. Therefore, electrotransport refers to at least one, and possibly a combination of the aforementioned transport mechanisms, which supplement the naturally occurring transfer modes.

Medical devices that include drug delivery by electrotransport are described, for example, in U.S. Pat. No. 5,674,196, to Donaldson, et al., U.S. Pat. No. 5,961,482, to Chin, et al., U.S. Pat. No. 5,983,131, to Weaver, et al., U.S. Pat. No. 5,983,134, to Otto, and U.S. Pat. No. 6,477,410, to Henley, et al., all of whose disclosures are incorporated herein by reference.

In addition to the aforementioned electrotransport processes, there are other electrically assisted drug delivery mechanisms, as follows:

Sonophoresis, or the application of ultrasound, induces growth and oscillations of air pockets, a phenomenon known as cavitation. These disorganize lipid bilayers thereby enhancing transport. For effective drug transport, a low frequency of between 20 kHz and less than 1 MHz, rather than the therapeutic frequency, should be used. Sonophoresis devices are described, for example, in U.S. Pat. Nos. 6,002,961, 6,018,678, and 6,002,961 to Mitragotri, et al., U.S. Pat. Nos. 6,190,315 and 6,041,253 to Kost, et al. U.S. Pat. No. 5,947,921 to Johnson, et al. and U.S. Pat. Nos. 6,491,657, and 6,234,990 to Rowe, et al., all of whose disclosures are incorporated herein by reference.

Ablation, or the literal slicing of tissue, by various means, is another method of forcing drugs through a biological barrier. In addition to mechanical ablation, for example with hypodermic needles, one may use laser ablation, cryogenic ablation, thermal ablation, microwave ablation, radiofrequency ablation or electrical ablation. In essence, electrical ablation is similar to electroporation, but tends to be more severe.

U.S. Pat. No. 6,471,696, to Berube, et al., describes a microwave ablation catheter, which may be used as a drug delivery device. U.S. Pat. No. 6,443,945, to Marchitto, et al., describes a device for pharmaceutical delivery using laser ablation. U.S. Pat. No. 4,869,248, to Narula describes a catheter for performing localized thermal ablation, for purposes of drug administration. U.S. Pat. Nos. 6,148,232 and 5,983,135, to Avrahami, describe drug delivery systems by electrical ablation. The disclosures of all of these are incorporated herein by reference.

### SUMMARY OF THE INVENTION

According to one aspect of the present invention, an apparatus is provided for delivering at least one therapeutic agent to a dental tissue of a subject. The apparatus comprises at least one electrode, a medicament layer including at least one therapeutic agent, an electrical signal source, and logic configured to control the electrical signal source. At least one electrode has oppositely disposed, dental mouthpiece-shaped first and second major surfaces. The first major surface is curved such that the first major surface substantially conforms to the contour of the dental tissue when the first major surface is in contact with the dental tissue. The medicament layer is disposed on at least a portion of the second major surface. The electrical signal source is for providing a signal having certain characteristics. The electrical signal source is electrically connected to at least one electrode. The certain characteristics of the electrical signal source comprise at least one orienting frequency and at least one motivating frequency sufficient to motivate at least one therapeutic agent into the dental tissue.

According to another aspect of the present invention, a system is provided for delivering at least one therapeutic agent to a dental tissue of a subject. The system comprises an apparatus and an electrical lead. The apparatus comprises at least one electrode, a medicament layer, an electrical signal source, and logic configured to control the electrical signal source. At least one electrode has oppositely disposed, dental mouthpiece-shaped first and second major surfaces. The first major surface is curved such that the first major surface substantially conforms to the contour of the dental tissue when the first major surface is in contact with the dental tissue. The medicament layer is disposed on at least a portion of the second major surface. The electrical signal source is for providing a signal having certain characteristics. The electrical signal source is electrically connected to at least one electrode. The certain characteristics of the electrical signal source comprise at least one orienting frequency and at least one motivating frequency sufficient to motivate at least one therapeutic agent into the dental tissue. The electrical lead includes oppositely disposed proximal and distal ends. The proximal end is electrically connected to the electrical signal source and the distal end is electrically connected to at least one electrode. The electrical lead is for delivering the electrical signal to at least one electrode.

According to another aspect of the present invention, a method is provided for delivering at least one therapeutic agent to a dental tissue of a subject. One step of the method includes providing an apparatus comprising at least one electrode, a medicament layer including at least one therapeutic agent, an electrical signal source, and logic configured to control the electrical signal source. At least one electrode has oppositely disposed, electrically-conductive first and second dental mouthpiece-shaped major surfaces. The medicament layer is disposed on at least a portion of the second major surface. The electrical signal source is electrically connected to at least one electrode. Next, the electrical signal source is caused to provide a signal having certain characteristics to motivate at least one therapeutic agent into the dental tissue.

According to another aspect of the present invention, a method is provided for delivering at least one therapeutic agent to the select region of a dental tissue of a subject. One step of the method includes providing an apparatus comprising at least one electrode, a medicament layer including at least one therapeutic agent, an electrical signal source, and logic configured to control the electrical signal source. At least one electrode has oppositely disposed, electrically-conductive first and second dental mouthpiece-shaped major surfaces. The medicament layer is disposed on at least a portion of the second major surface. The electrical signal source is electrically connected to at least one electrode. Next, at least one medicament layer and at least one electrode is shaped so that delivery of the electrical signal to at least one electrode motivates at least one therapeutic agent into the select region of the subject's mouth or dental tissue. The electrical signal source is then caused to provide an electrical signal to at least one electrode to motivate at least one therapeutic agent into the select region of the subject's mouth or dental tissue. The select region can include, but is not limited to, lips (labial mucosa), cheeks (buccal mucosa), the gingiva (the gums), the buccal, lingual, or soft palette of a mouth.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a perspective view showing a configuration of an apparatus for delivering a drug to a dental tissue applied to a human mouth constructed in accordance with one aspect of the present invention, shown here for illustration as to how the drug delivery system works;

FIG. 2A is a perspective view showing a configuration of an apparatus for delivering a drug to a dental tissue constructed in accordance with one aspect of the present invention, shown here for illustration as to how the drug delivery system works;

FIG. 2B is a cross-sectional view showing a configuration of the apparatus of FIG. 2A, shown here for illustration as to how the drug delivery system works;

FIG. 2C is a perspective view showing a configuration of the apparatus of FIG. 2A, shown here for illustration as to how the drug delivery system works;

FIG. 3A is a cross-sectional view of the mouth and dental tissue, shown here for illustration as to how the drug delivery system works;

FIG. 3B is a cross-sectional view of a tooth 310, shown here for illustration as to how the drug delivery system works;

FIG. 3C is a front view of the mouth and dental tissue, shown here for illustration as to how the drug delivery system works;

FIG. 3D is a front view of the actual anatomy of the gingival 26, shown here for illustration as to how the drug delivery system works;

FIG. 4 is a process flow diagram illustrating a method for delivering a drug to a dental tissue of subject according to another aspect of the present invention, shown here for illustration as to how the drug delivery system works;

FIG. 5A is a perspective view of an electrode;

FIG. 5B is a perspective view of an electrode in FIG. 5A shown in a flexed position;

FIG. 5C is a perspective view of an interdigitated electrode array having a first and second electrically conductive system separated by a non-conducting spacer;

FIG. 6A is a magnified view of a tooth 310 having pores.

FIG. 6B is a magnified view of the tooth having pores wherein a therapeutic agent contacts the tooth;

FIG. 6C and FIG. 6D are magnified views of the tooth having pores showing the therapeutic agent movement on the tooth;

FIG. 6E and FIG. 6F are magnified views of the tooth having pores showing the therapeutic agent movement into the pores;

FIG. 7 is a perspective view of a circular cavity created above the cementum-enamel junction of a tooth;

FIG. 8 is a table summarizing the UV spectroscopy results from MACROESIS™ and diffusion studies;

FIG. 9 is a table summarizing the average absorbance for the MACROESIS™ and the diffusion groups;

FIG. 10 is a graph showing the range of absorbance for the MACROESIS™ and the diffusion groups;

FIG. 11 is a table showing a comparison of average results from two rounds of studies.

### DETAILED DESCRIPTION

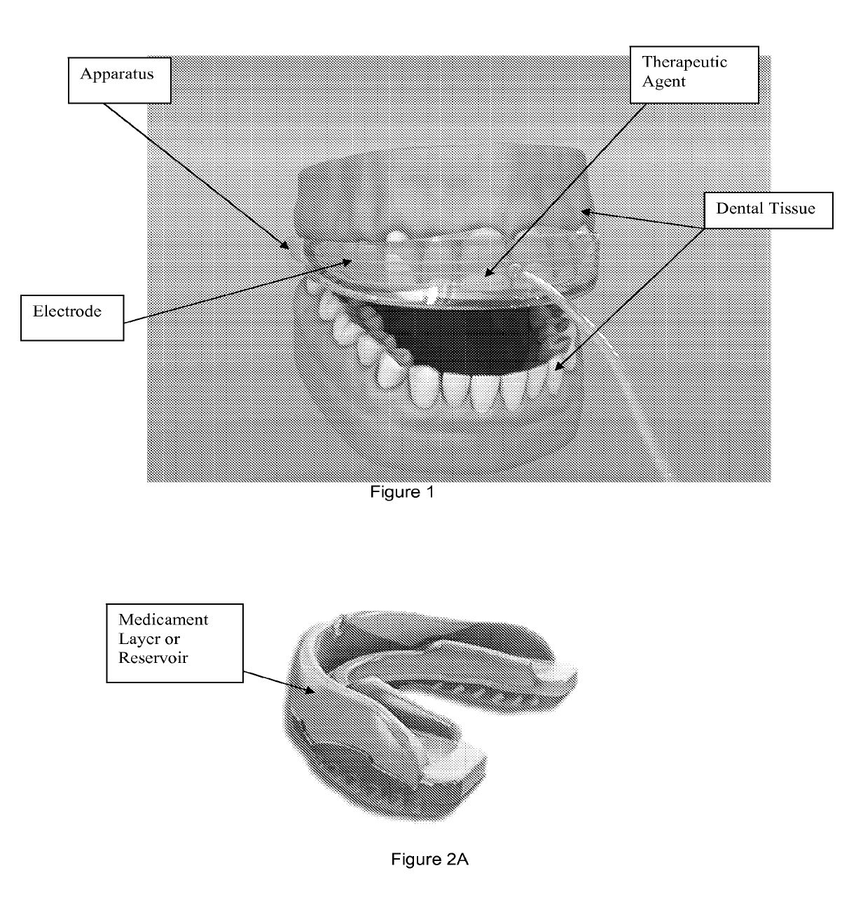

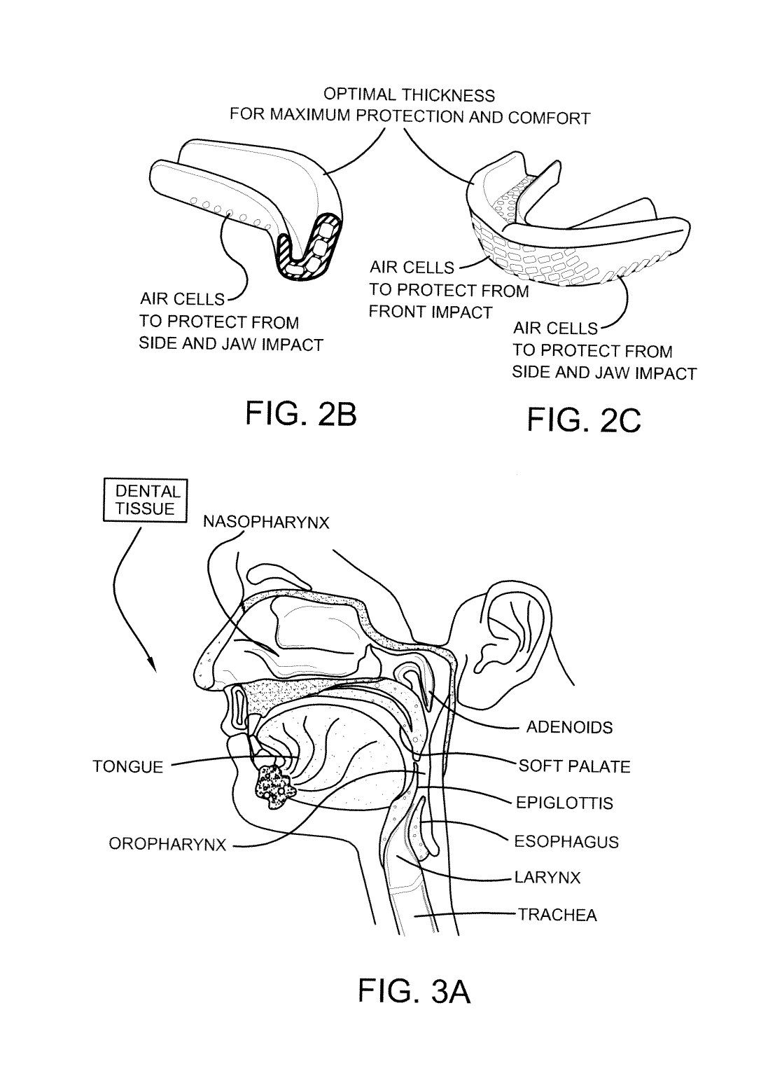

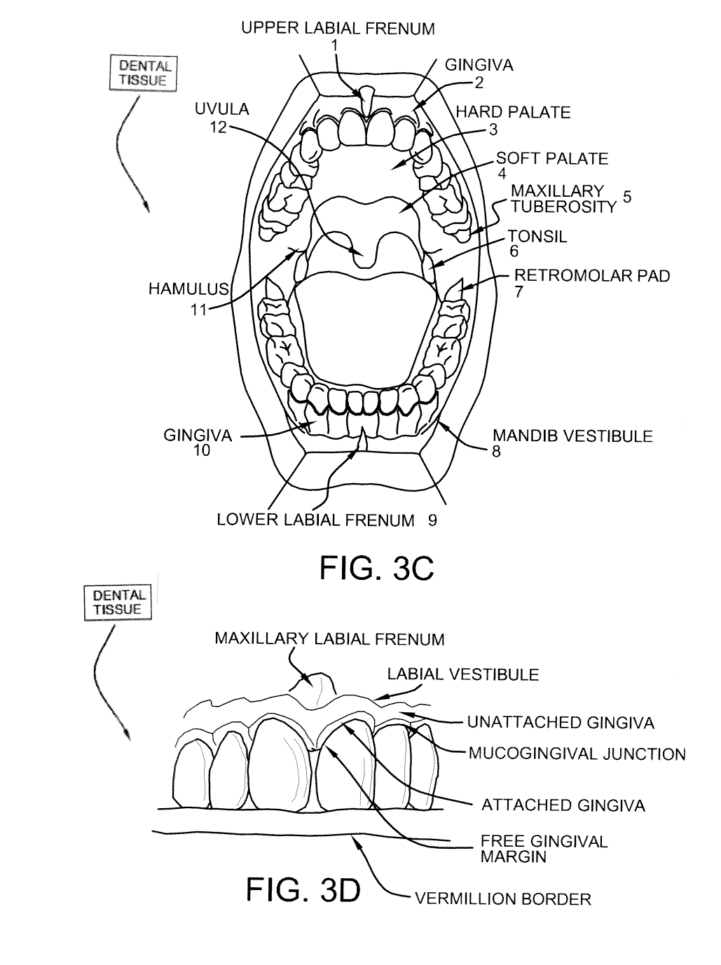

The present invention relates generally to an apparatus and method for delivering at least one therapeutic agent to a dental tissue, and more particularly to a dielectrophoretic apparatus and related method for delivering at least one therapeutic agent to a dental tissue of a subject. As representative of the present invention, FIGS. 1, 2A-C illustrate an apparatus 10 for delivering at least one therapeutic agent to a dental tissue of a subject. One aspect of the present invention provides a non-invasive apparatus 10 and method 12 (FIG. 4) that takes advantage of the principles of dielectrophoresis to modulate delivery of at least one therapeutic agent to dental tissue. Unlike conventional therapeutic agent delivery modalities, one aspect of the present invention provides increased patient safety, the ability to deliver both polar and non-polar agents of varying size, programmable dose control, and potentially lower cost of subject care.

Unless otherwise defined, all technical terms used herein have the same meaning as commonly understood by one of ordinary skill in the art to which the present invention pertains.

In the context of the present invention, the term “dental tissue” can refer to any one or combination of the tissues comprising the mouth or dental tissue, and tissues neurologically connected to (but distinct from) the mouth or dental tissue, including but not limited to, the gums, a tooth, teeth,a lip, a jaw, the hard palette, soft palette, gingival, buccal, lingual, or labial frenum.

As used herein, the term “subject” can refer to any warm-blooded organism including, but not limited to, humans, pigs, rats, mice, dogs, goats, sheep, horses, monkeys, apes, rabbits, cattle, etc.

As used herein, the terms “therapeutic agent”, “drug”, “agent”, “chemical compound”, and “chemical substance” can refer to any polar or non-polar molecule or moiety that is capable of exhibiting a dipole moment when exposed to an electric field. The terms can include, but are not limited to, therapeutically effective agents (i.e., agents that are capable of having a biological effect), such as pharmaceutical agents, drugs, or biological agents.

As used herein, the term “medicament layer” can refer to a suitable reservoir for storing and releasing at least one therapeutic agent, either with or without a vehicle.

As used herein, the term “vehicle” can refer to any non-toxic carrier composition suitable for administration of a drug or agent into dental tissue. Examples of vehicles can include any of the standard pharmaceutical carriers, such as a phosphate buffered saline solution, water, emulsions (e.g., oil/water emulsions), various types of wetting agents, and excipients.

As used herein, the term “signal” can refer to voltage signals and current signals.

As used herein, the term “logic” can refer to hardware, firmware, software and/or combinations thereof to perform a function(s) or an action(s), and/or to cause a function or action from another component. For example, based on a desired application or need, logic may include a software controlled microprocessor, discreet logic, such as an application specific integrated circuit (ASIC), a programmed logic device, memory device containing instructions, or the like. “Logic” may also be fully embodied as software on a computer-readable medium.

As used herein, the term “therapeutically effective amount” can refer to that amount of a therapeutic agent that results in amelioration of symptoms or a prolongation of survival in a subject with a dental disease or condition. A therapeutically effective amount relieves to some extent one or more symptoms of a dental disease or condition or returns to normal either partially or completely one or more physiological or biochemical parameters associated with or causative of the dental disease or condition.

As used herein, the term “subject's mouth ” or “delivery site ” can include, but is not limited to, any one or combination of the tissues comprising gingival, mandible, and vestibule etc., and tissues neurologically connected to (but distinct from) gingival, mandible, and vestibule etc.

As used herein, the term “subject's mouth ” or “delivery site” can include, but is not limited to, any one or combination of the tissues comprising hamlus, uvula, upper labial frenum, hard palate, soft palate, maxillary tuberosity, tonsil, and retromolar pad etc., and tissues neurologically connected to (but distinct from) hamlus, uvula, upper labial frenum, hard palate, soft palate, maxillary tuberosity, tonsil, and retromolar pad etc.

One aspect of the present invention includes an apparatus 10 (FIGS. 1, 2A-C) and method 12 (FIG. 4) for delivering at least one therapeutic agent to a dental tissue of a subject via dielectrophoresis. To date, most devices and methods for delivering therapeutic agents (e.g., drugs) aided by an electromotive force have involved the use of a simple cathode or anode coupled with a drug source and a direct current (DC) electrical signal. The use of a DC electrical signal alone, however, may have certain disadvantages including, but not limited to, the formation of harmful or undesirable chemical byproducts at the cathode or anode. Moreover, such devices and methods are characterized as “iontophoresis” devices and methods since they are primarily limited to effecting transport of ionic or strongly polar compounds. Many compounds (including drugs) may not be polar or ionic and/or may be difficult to ionize, rendering the use of iontophoretic devices and methods ineffective on such compounds.

Regarding polarization, many compounds exhibit no dipole (areas of equal charge separated by a distance) in the absence of an electric field because no free charges exist on any site of the compound or, if present, the charges are randomly distributed such that no net charge exists on the compound. Such compounds may be polarized and achieve a net dipole if they contain sites capable of being acted upon by an applied electric field. Such sites may comprise any distinct chemical group or moiety within a larger compound that is capable of being attracted or repelled by an applied electric field. The sites are termed “nanosites” when their size is less than about 100 nanometers. Such nanosites can include, for example, carbonyl, sulfoxide, nitro, and hydroxide groups.

Electrophoresis is based on migration of charged species in an electromagnetic field. Ions, molecules, and particles with charge carry current in solutions when an electromagnetic field is imposed. Movement of a charged species tends to be toward the electrode of opposite charge. The voltages for continuous electrophoresis are rather high (several hundred volts).

Electroporation is the process in which a biological barrier is subjected to a high voltage alternating-current (AC) surge, or pulse. The AC pulse creates temporary pores in the biological membrane, specifically between cells. The pores allow large molecules, such as proteins, DNA, RNA, and plasmids to pass through the biological barrier.

Dielectrophoresis is the phenomenon in which a force is exerted on a dielectric particle when it is subjected to a non-uniform electric field. This force does not require the particle to be charged. For a field-aligned cylinder of radius a and half-length b with dielectric constant εₚ in a medium with constant εₘ, the dielectrophoretic force is given by:

$${F}_{dep} = \frac{{πα}^{2} b}{3} {ε}_{m} Re \{ \frac{\text{?} - \text{?}}{\text{?}} \} ∇ {\vert {E}^{->} \vert}^{2} . \\ \text{?} \text{indicates text missing or illegible when filed}$$

Unlike iontophoresis, one aspect of the present invention includes a dielectrophoretic apparatus 10 (FIGS. 1, 2A-C) and method 12 (FIG. 4) for motivating any polarizable chemical compound, including compounds that are difficult to polarize, such as non-polar drugs and large molecule compositions. Dielectrophoresis involves providing a non-uniform alternating (AC) or DC electric field to a compound or agent. The non-uniform electric field, in addition to inducing a dipole in the compound or agent, sets up an electrical field gradient that provides an electromotive force on the newly polarized compound or agent, the magnitude and direction of which are dependent on several factors. A more detailed explanation of dielectrophoresis and its operating principles are disclosed in U.S. patent application Ser. No. 11/874,859 (hereinafter, “the '859 application”), the entirety of which is hereby incorporated by reference.

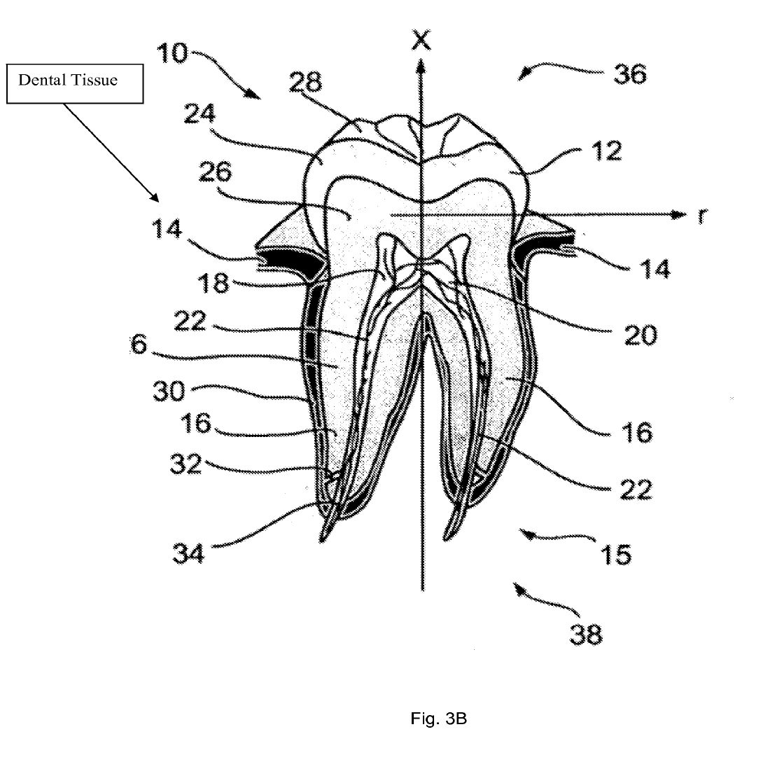

One aspect of the present invention includes an apparatus 10 (FIGS. 1, 2A-C) and method 12 (FIG. 4) for delivering at least one therapeutic agent to a dental tissue of a subject, such as a cross-sectional view of a human mouth or dental tissue 20 (FIG. 3A). As shown in FIG. 3A, inside of the throat is the pharynx, from the oral and nasal cavities (see mouth, nose) to the trachea 405 and esophagus 403. It has three connected sections: the nasopharynx 406, at the back of the nasal cavity; the oropharynx 408, in the back of the oral cavity down to the epiglottis 402 (a flap of tissue that closes off the larynx 404 during swallowing); and the laryngopharynx, from the epiglottis 402 to the esophagus 403. The oropharynx 408 contains the palatine tonsils. The eustachian tubes connect the middle ears to the pharynx, allowing air pressure on the eardrum to be equalized. Disorders include pharyngitis, tonsillitis, and cancer.

As shown in FIG. 3B is a cross-sectional view of a tooth 310. The basic parts of a tooth are: a crown 312, the portion of tooth above a gum 314, and a root or roots 316, which anchor the tooth in a jawbone 315. A pulp 318 is arranged within a pulp chamber 320 and within a root canal or root canals 322.

Crown 312 is formed of an inner structure of dentine 326 and an external layer of enamel 324, which defines a chewing surface 328. There may be one, two, or more roots 316. Each has an external layer of cement 330, inner structure of dentine 326, and one root canal 322. Pulp 318 is formed of tiny blood vessels, which carry nutrients to the tooth, and nerves, which give feeling to the tooth. These enter root canals 322 via accessory canals 332 and root-end openings 334.

Tooth 310 may define a cylindrical coordinate system of a longitudinal axis x, and a radius r. A coronal or incisal end 336 may be defined as the end above gum 314 and an apical end 338 may be defined as the end below it.

As shown in FIG. 3C is a brief overview of the mouth and dental tissue, which relate to the present invention. The little thing that hangs down in the back of the throat is called the uvula 412. The uvula 412 is attached to the back of the soft palate.

The labial frenum 401 and 409 is a little tag of tissue in the center of the upper and the lower lip that attaches the lip to the gums.

The tonsils 406 are at the border between the mouth and the throat.

The mandib vestibule 408 is the curvature of the tissue where the lining of the inside of the lips (labial mucosa) or cheeks (buccal mucosa) meet the gingiva 26 (the gums).

The vermillion border is the junction of the dry, pink part of the lip with the skin of the face. The labial (lip) vestibule 409 is marked on the diagram. The upper labial frenum 401 is also visible.

The roof of the mouth has two distinctive parts. The hard palate 403 is the tough, leathery, non movable part of the roof of the mouth that is attached to the inside of the teeth and curves up to make the vault of the palate. The soft palate 404 lies behind the hard palate 403 and is closer to the back of the throat.

The hamulii 411 (singular hamulus) are hard little bumps in the corners of the soft palate just where the soft palate meets the very back of the tuberosities.

The maxillary tuberosities 405 are the tough, hard humps behind the top back teeth on both sides of the dental arch (note that both upper and lower teeth are arranged in “arches”). These humps have underlying bone and hard gum tissue covering them, and they are persistent, permanent parts of the mouth, even if all the upper teeth are extracted.

The retromolar pad 407 is similar to the maxillary tuberosities discussed above, except that it is behind the last lower molars, and it is not underlain by a corresponding hump of bone.

As shown in FIG. 3D is a brief overview of the anatomy of the gingival 26, known commonly as the “gums”, which relate to the present invention. The lighter pink colored gum tissue is called the “attached gingiva” 507 because it is firmly attached to the underlying bone. It has the same consistency as the gums overlying the hard palate discussed above. The darker pink tissue above it is called the unattached gingival 504, also called the alveolar mucosa. It is not firmly attached to the underlying bone. The junction between them is called the mucogingival junction 505. The small margin of tissue on the diagram is called the free or marginal gingiva 508 (sometimes called the free gingival margin 508), and it is the unattached, sleevelike portion of the gingiva that encircles the tooth to form the gingival sulcus.

In one aspect of the present invention, the apparatus 10 (FIGS. 1, 2A-C) comprises at least one electrode 44, a medicament layer 46 including at least one therapeutic agent, an electrical signal source, and logic configured to control the electrical signal source. At least one electrode 44 (FIGS. 1, 2A-C) can comprise any one or a combination of electrodes capable of providing an electric field to an area sufficient to motivate at least one therapeutic agent into a dental tissue. To ensure proper transmission of electrical energy, at least one electrode 44 includes at least two separate, electrically-conductive portions or components that are biased against one another. At least one electrode 44 can comprise a single electrode or, alternatively, two or more independent, electrically-conductive members separated by an insulator. For example, at least one electrode 44 can comprise any irregularly-shaped or non-uniform electrode capable of providing a non-uniform electric field to an area sufficient to induce dielectrophoretic transport of at least one therapeutic agent.

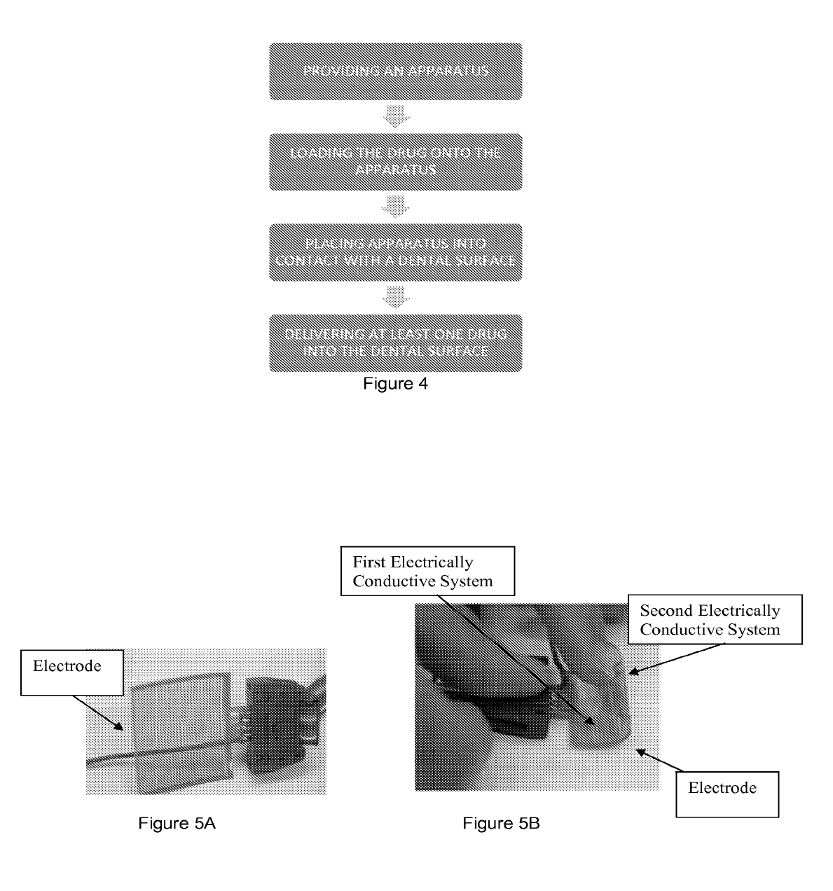

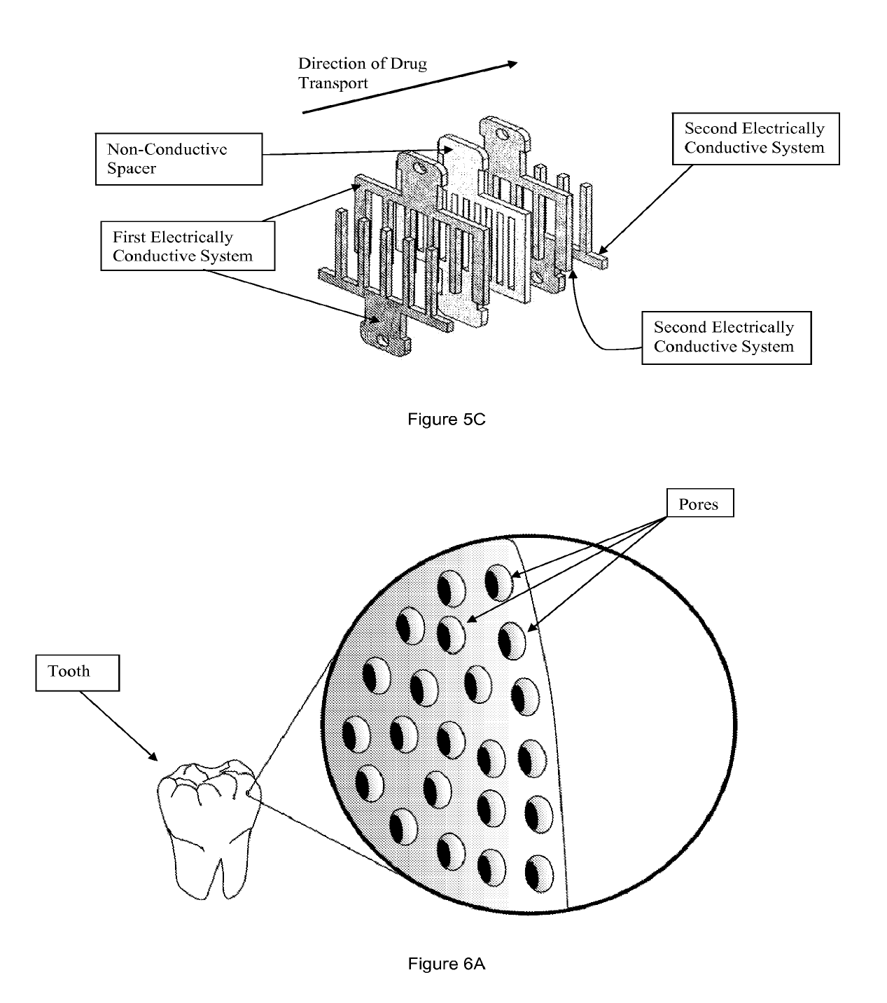

At least one electrode 44 has a flexible, dental mouthpiece-shaped configuration that is contoured to the three-dimensional shape of the dental tissue (e.g., the mouth or dental tissue 20). At least one electrode 44 includes an electrically-conductive first major surface 50 oppositely disposed from an electrically-conductive second major surface 52 (FIG. 5C). The first major surface 50 is curved such that the first major surface substantially conforms to the contour of the dental tissue when the first major surface is in contact with the dental tissue. For example, the first major surface 50 can have a radius of curvature substantially similar to the radius of curvature of the gingival 26 or the lingual 22. As described in more detail below, at least one electrode 44 can be judiciously shaped to facilitate delivery of at least one therapeutic agent to a select region of dental tissue.

At least one electrode 44 can be made of any material capable of conducting an electrical current, such as platinum, platinum-iridium, stainless steel, gold-plated copper, or the like. Additionally or optionally, at least a portion of at least one electrode 44 is embedded within a polymeric material (or other similar material) (e.g., silicone) to protect dental tissue from abrasion, promote biocompatibility and/or electrical conduction, and facilitate fixing at least one electrode in place during delivery.

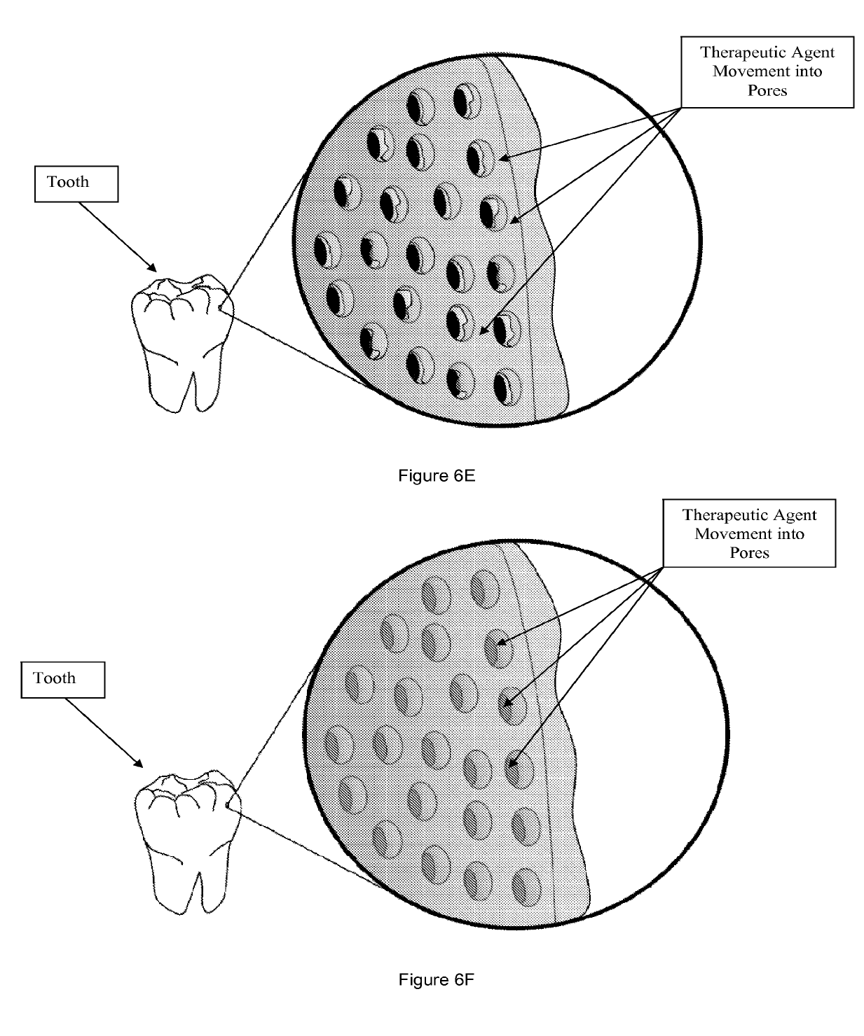

As one example of the present invention, it will be appreciated that ongoing reference to at least one electrode 44 shall include an interdigitated electrode. In general, an interdigitated electrode can include any set of at least two electrodes that contain interwoven projections. As shown in FIGS. 9A-C, at least one electrode 44 (e.g., an interdigitated electrode) is comprised of a first electrically-conductive member 128 that is separated by an insulator from a second electrically-conductive member 130. Each of the first and second electrically-conductive members 128 and 130 comprise a “comb” electrode (i.e., an electrode having a number of relatively long, flat prongs that are evenly spaced) whose prongs are interleaved with one another. At least one electrode 44 (e.g., an interdigitated electrode) can additionally include at least one passage 54 sufficient to allow at least one therapeutic agent to pass therethrough. At least one electrode 44 (e.g., an interdigitated electrode) can have a material composition and dimensions that allow for substantial flexibility and conformability to dental tissue. As noted above, the first and second electrically-conductive members 128 and 130 comprising at least one electrode 44 (e.g., an interdigitated electrode) may be spaced apart by an insulator (not shown) made of any insulating material suitable for use in designing an arrangement of electrodes and/or circuits (e.g., fiberglass or TEFLON). More specific details concerning the design and function of interdigitated electrodes are disclosed in the '859 application.

As shown in FIG. 2A, the medicament layer 46 is disposed on at least a portion the second major surface 52 (FIGS. 4A-B) of at least one electrode 44 (e.g., an interdigitated electrode). The medicament layer 46 can be shaped to preferentially deliver at least one therapeutic agent to a select region of dental tissue. The dental mouthpiece-shaped medicament layer 46 shown in FIGS. 4A-B, for example, can facilitate selective delivery of at least one therapeutic agent to the gingival 26 of the mouth or dental tissue 20 while also avoiding or mitigating delivery of at least one therapeutic agent to the tooth 22. It will thus be appreciated that the medicament layer 46 can have any size and shape, depending upon the particular application of the present invention.

The medicament layer 46 can comprise a matrix formed from a sponge, gel (e.g., hydro-gel), viscous liquid, or the like. The medicament layer 46 can be applied to the second major surface 52 of at least one electrode 44 (e.g., an interdigitated electrode) by spraying, coating or placing. The material(s) used to form the medicament layer 46 can include any one or combination of materials capable of storing and releasing at least one therapeutic agent and, optionally, at least one vehicle. For example, the medicament layer 46 can be comprised of a biocompatible, non-biodegradable polymeric material made from a homopolymer, a copolymer, straight polymers, branched polymers, cross-linked polymers, stimuli-responsive polymers, or a combination thereof. Examples of such polymers can include silicone, polyvinyl alcohol, ethylene vinyl acetate, polylactic acid, nylon, polypropylene, polycarbonate, cellulose, cellulose acetate, polyglycolic acid, polylactic-glycolic acid, cellulose esters, polyethersulfone, acrylics, their derivatives, and combinations thereof. It should be appreciated that the medicament layer 46 may also be disposed on the first major surface 50 of at least one electrode 44 (e.g., an interdigitated electrode) or at least partially embedded therein.

The medicament layer 46 can include any one or combination of polar and/or non-polar therapeutic agents. For example, the medicament layer 46 can include such ophthalmic medications as anti-infectives, antibiotics, anti-inflammatory agents (e.g., triamcinolone), non-steroidal anti-inflammatory agents, anti-fungal agents, glaucoma medications (e.g., alpha-2 agonists, beta blockers, carbonic anhydrase inhibitors, miotics, prostaglandin agonists, and sympathomimetics), mast cell stabilizers, anti-proliferative agents, steroids, corticosteroids, hormones, small molecules, cytokines, growth factors, antibodies or antibody fragments, immune system modulators, vectors, polynucleotides, nucleic acids, RNAs, miRNAs, siRNAs, DNAs, aptamers, carbohydrates, recombinant or native peptides, polypeptides and proteins (e.g., TIMP-3), enzymes, enzyme inhibitors, and combinations thereof. More specific examples of such therapeutic agents, as well as others are known in the art, including antiarthritics, antibiotics, anticoagulant antagonists, antihypertensive medications, antineoplastics, and antirheumatic agents.

Additionally, blood modifiers may be used, for example, anticoagulants, antiplatelet agents, and thrombolytic agents.

Furthermore, cardiovascular agents may be used, for example, adrenergic blockers (central, peripheral and combinations), alpha/beta adrenergic blockers, angiotensin convertin enzyme inhibitors, angiotensin convertin enzyme inhibitors with calcium channel blockers, angiotensin convertin enzyme inhibitors with diuretics, angiotensin II receptor antagonists, angiotensin II receptor antagonists with diuretics, antiarrhythmics (Groups I, II, III, miscellaneous), antilipemic agents, HMG-CoA reductase inhibitors, nicotinic acid, beta adrenergic blocking agents, beta adrenergic blocking agents with diuretics, calcium channel blockers, miscellaneous cardiovascular agents, vasodilators (coronary, peripheral, pulmonary and combinations), and vasopressors.

Additionally, respiratory agents may be used, for example, bronchodilators, sympathomimetics and combinations, xanthine derivatives and combinations, miscellaneous respiratory agents, and respiratory stimulants.

Furthermore, skin and mucous membrane agents may be used, for example, antihistamines and combinations, and antineoplastics.

Additionally, viagra and similar agents may be used.

Additionally, antidepressants, and drugs for mental diseases may be used.

Furthermore, insulin and similar agents may be used.

Additionally, drugs for local therapies may be used, for example:
i. glucocorticosteroids such as betamethasone, triamcinolone, fluocinolone and similar drugs, antifungals, such as econazole, miconazole, clotrimazole, bifonazole, ketoconazole, and itraconazole;
ii. antivirals, such as acyclovir; and
iii. antibiotics, such as cefazolin, amoxycillin, vancomycin, gentamicine, and chloramphenicol.

Furthermore, drugs for systemic and chronic therapies may be used, for example:
i. antineoplastics, such as 5-fluorouracil, ftorafur, and hydroxyurea;
ii. antiepileptics, such as carbamazepine, valproate, perfenazine, phenytoine, and primidone;
iii. antiarrhythmics, such as atenolol, and timolol;
iv. antihypertensives, such as enalapril;
v. anti-HIV drugs, such as AZT;
vi. immunosuppressive agents, such as sirolimus, and tacrolimus;
vii. CNS candidates, such as galantamine;
viii. Alzheimer disease drugs, such as risperidone;
ix. drug-addiction treatment, such as buprenorphine, and naloxone;
x. chronic pain/palliative tumour therapy, such as opiate or opiate-like medication; and
xi. rheumatic pain, such as non-steroidal anti-inflammatory medication.

Additionally, drugs for diseases with a circadian pattern may be used.

Additionally, other drugs may be used.

The drugs contained in the devices in accordance with the present invention may be of large molecules, peptide drugs, or others, which might be absorbed in the general circulation directly from the oral cavity or oral tissues, without passing through the Gastrointestinal tract with all its limitations. As such, the present invention offers an alternative approach to gastro retentive systems, as well as to conventional buccal and sublingual administration and to conventional oral controlled release dosage forms.

Additionally, the drugs included in the devices may be of any type regarding its physical and chemical properties. In case of poorly soluble drugs, improved solubility approaches, such as complexation or sub-micronization (nano-systems), stabilized in any manner suitable for improved solubility, may be used.

It will be appreciated that the apparatus 10 can include more than one medicament layer 46, and that each medicament layer can contain the same or different type of therapeutic agent. Additionally, it will be appreciated that a single medicament layer 46 can include two or more compartments (not shown), each of which is also made from a gel, viscous liquid, etc. If appropriate, mixtures of therapeutic agents can be stored in a common compartment while other single therapeutic agents (or mixtures) are stored in one or more separate compartments. The release characteristics of the respective compartments can be adjusted according to specific applications of the present invention.

The apparatus 10 additionally comprises an electrical signal source for providing an electrical signal to at least one electrode 44 (e.g., an interdigitated electrode). The electrical signal source 48 is capable of providing an AC signal, a DC signal, or a combination thereof. The electrical signal source 48 can be electrically connected to at least one electrode 44 (e.g., an interdigitated electrode) via a direct electrical link or a wireless link (e.g., an RF link). Proximal and distal ends of an electrical lead 90 can be electrically connected to the electrical signal source 48 and at least one electrode 44 (e.g., an interdigitated electrode), respectively.

In one example of the present invention, the electrical signal source 48 provides an electrical signal having certain characteristics. The certain characteristics can comprise at least one orienting frequency to orient at least one therapeutic agent, and at least one motivating frequency sufficient to motivate at least one therapeutic agent into the dental tissue. For example, at least one orienting frequency can comprise an AC signal having a relatively low frequency, and the motivating frequency can comprise an AC signal having a relatively high frequency. Alternatively, at least one orienting frequency can comprise an AC signal delivered from an AC signal source, and at least one motivating frequency can comprise a DC signal delivered from a DC signal source. Other examples of electrical signals having certain characteristics are disclosed in the '859 application and described below.

The apparatus 10 additionally includes logic configured to control the electrical signal source 48. The logic may be configured to monitor and record current and phase data from at least one electrode 44 (e.g., an interdigitated electrode) and to calculate dielectric information regarding at least one therapeutic agent as a function of the electrical signal frequency. Dielectric information may include, but is not limited to, capacitance, conductance, permittivity (ε′), dielectric loss factor (ε″), and impedance information. Dielectric information may be plotted or stored as a function of electrical signal frequency to facilitate selection of appropriate operating frequencies that allow for at least one therapeutic agent to be motivated into dental tissue. More specific details concerning the logic used to modulate the electrical signal are disclosed in the '859 application.

FIG. 4 is a process flow diagram illustrating another aspect of the present invention. In FIG. 4, a method 12 is provided for delivering at least one therapeutic agent to a dental tissue of a subject. The method 12 includes providing an apparatus 10 at Step 14. The apparatus 10 can be identically or similarly constructed as the apparatus shown in FIGS. 1, 2A-C. For example, the apparatus 10 can comprise at least one electrode 44 (e.g., an interdigitated electrode), a medicament layer 46 including at least one therapeutic agent, an electrical signal source 48, and logic configured to control the electrical signal source.

At Step 15, a therapeutic agent is loaded into the apparatus 10.

At Step 16, at least a portion of the apparatus 10 is placed into contact with the dental tissue or dental surface of the subject. The placement location, type of therapeutic agent (or agents) comprising the medicament layer 46, and the size and shape of the medicament layer will depend on the subject's anatomy, the age of the subject, the presence or absence of a dental condition or disease, as well as other factors. To treat gingival inflammation, for example, the medicament layer 46 can include a desired concentration of gentamicine. Alternatively, in a subject with HIV, the medicament layer 46 can include a desired concentration of AZT.

Prior to contacting the apparatus 10 with the dental tissue, the medicament layer 46 can be shaped to optimize delivery of the therapeutic agent(s) to the dental tissue. In a subject suffering from mouth or dental tissue disease, for example, the medicament layer 46 can be shaped as shown in FIGS. 4A-B to optimize delivery of the therapeutic agent(s) through the gingival 26 and into at least one tissue comprising the delivery site, or dental tissue 20. Alternatively, in a subject suffering from gingival inflammation, the medicament layer 46 can have a circular, oval-shaped, or dental mouthpiece-shaped configuration and be placed on or near the center of at least one electrode 44 (e.g., an interdigitated electrode) adjacent the gingival 26 to facilitate delivery of the therapeutic agent(s) into the inflamed dental tissue.

If it has not been done so already, the medicament layer 46 is placed into contact with the second major surface 52 of at least one electrode 44 (e.g., an interdigitated electrode) (FIG. 9).

If it has not been done so already, the electrical signal source 48 can next be electrically connected to at least one electrode 44 (e.g., an interdigitated electrode).

The apparatus 10 is positioned adjacent to the subject's mouth or dental tissue 20 so that the curvature of the first major surface 50 substantially conforms to the contour of the mouth or dental tissue's surface. It will be appreciated that the curvature of the first major surface 50 and the curvature of the subject's mouth or dental tissue 20 can be determined prior to placing the apparatus 10 to ensure a snug fit between the first major surface and the mouth or dental tissue's surface. Additionally, it will be appreciated that the apparatus 10 can be placed at other positions (e.g., over the subject's mouth or dental tissue 112 and 114) to deliver the therapeutic agent(s) to the dental tissue.

At Step 18, at least one therapeutic agent is motivated or delivered into the dental tissue by causing the electrical signal source 48 to provide an electrical to at least one electrode 44 (e.g., an interdigitated electrode). In one example of the method 12, the electrical signal source 48 can be activated to send an AC signal having certain characteristics to at least one 44 (e.g., an interdigitated electrode). The electrical signal source 48 can be activated to cycle through at least one decade of frequencies ranging from about 0.1 Hz to about 20,000 Hz. For example, an AC signal can have an orienting frequency of about 0.1 Hz to about 100 Hz, a motivating frequency of between about 100 Hz and about 20,000 Hz, and an amplitude of between about 1 V to about 10 V. Additionally, an AC signal can be applied for between about 1 minute and about 30 minutes. A more specific description of the electrical signal and the logic used to modulate the electrical signal is disclosed in the '859 application.

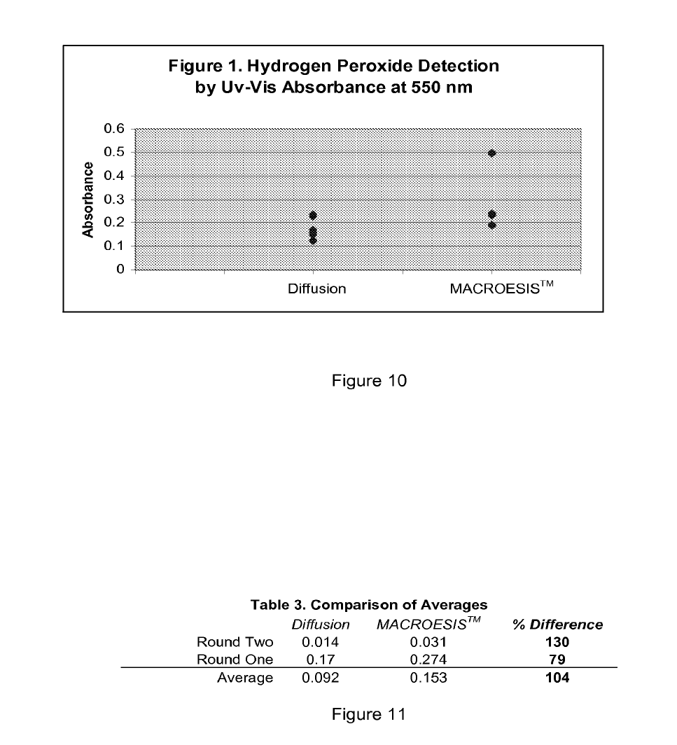

Application of the electrical signal motivates at least one therapeutic agent into the dental tissue. As shown in FIGS. 11-12, for example, application of an AC signal to at least one electrode 44 (e.g., an interdigitated electrode) provides a non-uniform electric field, thereby inducing a dipole on at least one therapeutic agent(s). This, in turn, sets up an electrical field gradient that provides an electromotive force on the newly polarized agent(s) to drive the agent(s) into the subject's mouth or dental tissue 20. By modifying the electrical signal (i.e., the frequency, voltage, and time of application), the logic, the apparatus 10 (e.g., at least one electrode 44 or the medicament layer 46), or a combination thereof, the therapeutic agent(s) can be selectively delivered to a desired portion of the the subject's mouth or dental tissue, e.g., a buccal, lingual, gingiva, or soft palette (FIGS. 3A-D).

It will be appreciated that the method 12 and the apparatus 10 of the present invention can be used to deliver a therapeutically effective amount of at least one therapeutic agent to dental tissue and thereby treat a variety of dental diseases or conditions. Examples of dental conditions or diseases that may be treated according to the method can include, but are not limited to cancers of the head and neck, including cancers of the oral cavity, oropharyngeal cancer, cancer of the nose, cancer in the bones of the face, cancer of the ear, cancer of the dental tissue, skin of the dental tissue, cancer of the lymph nodes, cancer of the thyroid gland, larynx and salivary glands, paranasal sinuses, the nasopharynx and combinations thereof.

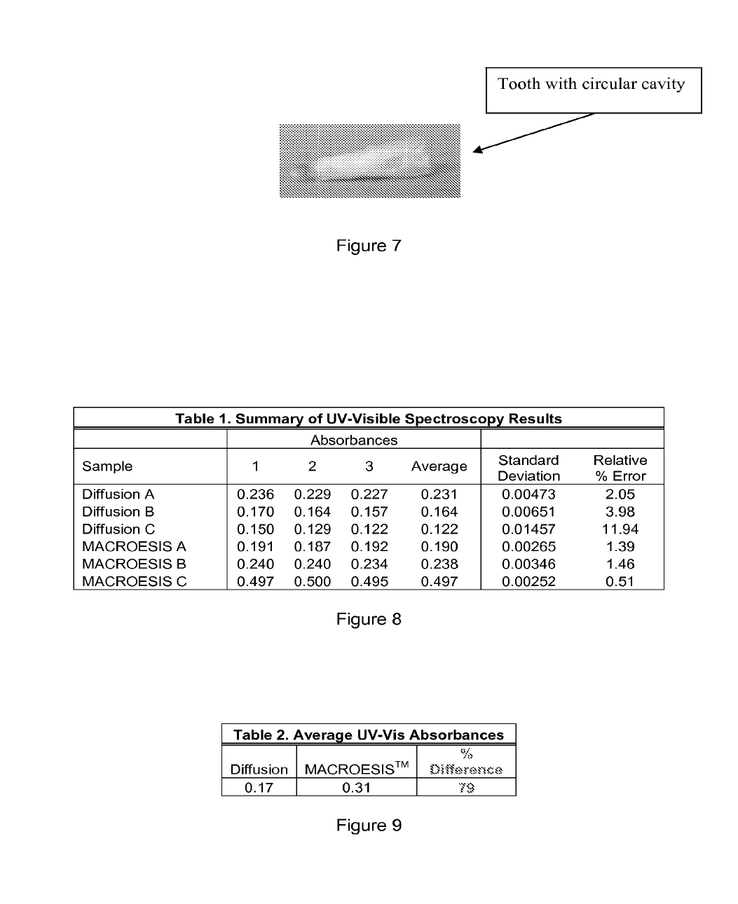

In one aspect of the present invention, the apparatus 10 (FIG. 10) comprises at least one electrode 44, a medicament layer 46 including at least one therapeutic agent, an electrical signal source, and logic configured to control the electrical signal source. At least one electrode 44 (FIGS. 1, 2A-C) can comprise any one or combination of electrodes capable of providing an electric field to an area sufficient to motivate at least one therapeutic agent into a dental tissue. To ensure proper transmission of electrical energy, at least one electrode 44 includes at least two separate, electrically-conductive portions or components that are biased against one another. At least one electrode 44 can comprise a single electrode or, alternatively, two or more independent, electrically-conductive members separated by an insulator. For example, at least one electrode 44 can comprise any irregularly-shaped or non-uniform electrode capable of providing a non-uniform electric field to an area sufficient to induce dielectrophoretic transport of at least one therapeutic agent.

At least one electrode 44 has a flexible, dental mouthpiece-shaped configuration that is contoured to the three-dimensional shape of the dental tissue (e.g., the mouth or dental tissue 20). At least one electrode 44 includes an electrically-conductive first major surface 50 oppositely disposed from an electrically-conductive second major surface 52 (FIGS. 4A-B). The first major surface 50 is curved such that the first major surface substantially conforms to the contour of the dental tissue when the first major surface is in contact with the dental tissue. For example, the first major surface 50 can have a radius of curvature substantially similar to the radius of curvature of the gingiva 26 or buccal 22. As described in more detail below, at least one electrode 44 can be judiciously shaped to facilitate delivery of at least one therapeutic agent to a select region of dental tissue.

At least one electrode 44 can be made of any material capable of conducting an electrical current, such as platinum, platinum-iridium, stainless steel, gold-plated copper, or the like. Additionally or optionally, at least a portion of at least one electrode 44 is embedded within a polymeric material (or other similar material) (e.g., silicone) to protect dental tissue from abrasion, promote biocompatibility and/or electrical conduction, and facilitate fixing at least one electrode in place during delivery.

As one example of the present invention, it will be appreciated that ongoing reference to at least one electrode 44 shall include an interdigitated electrode. In general, an interdigitated electrode can include any set of at least two electrodes that contain interwoven projections. As shown in FIGS. 9A-C, at least one electrode 44 (e.g., an interdigitated electrode) is comprised of a first electrically-conductive member 128 that is separated by an insulator from a second electrically-conductive member 130. Each of the first and second electrically-conductive members 128 and 130 comprise a “comb” electrode (i.e., an electrode having a number of relatively long, flat prongs that are evenly spaced) whose prongs are interleaved with one another. At least one electrode 44 (e.g., an interdigitated electrode) can additionally include at least one passage 54 sufficient to allow at least one therapeutic agent to pass therethrough. At least one electrode 44 (e.g., an interdigitated electrode) can have a material composition and dimensions that allow for substantial flexibility and conformability to dental tissue. As noted above, the first and second electrically-conductive members 128 and 130 comprising at least one electrode 44 (e.g., an interdigitated electrode) may be spaced apart by an insulator (not shown) made of any insulating material suitable for use in designing an arrangement of electrodes and/or circuits (e.g., fiberglass or TEFLON). More specific details concerning the design and function of interdigitated electrodes are disclosed in the '859 application.

As shown in FIG. 10, the medicament layer 46 is disposed on at least a portion the second major surface 52 (FIGS. 4A-B) of at least one electrode 44 (e.g., an interdigitated electrode). The medicament layer 46 can be shaped to preferentially deliver at least one therapeutic agent to a select region of dental tissue. It will thus be appreciated that the medicament layer 46 can have any size and shape, depending upon the particular application of the present invention.

The medicament layer 46 can comprise a matrix formed from a sponge, gel (e.g., hydro-gel), viscous liquid, or the like. The medicament layer 46 can be applied to the second major surface 52 of at least one electrode 44 (e.g., an interdigitated electrode) by an elongated tube. The tube may have a first end and an opposing second end. The first end and an opposing second of the tube are connected to the medicament layer 46 and the drug reservoir portion of the device, respectively

The medicament layer 46 can include any one or combination of polar and/or non-polar therapeutic agents. More specific examples of such therapeutic agents, as well as others are known in the art.

It will be appreciated that the apparatus 10 can include more than one medicament layer 46, and that each medicament layer can contain the same or different type of therapeutic agent. Additionally, it will be appreciated that a single medicament layer 46 can include two or more compartments (not shown), each of which is also made from a gel, viscous liquid, etc. If appropriate, mixtures of therapeutic agents can be stored in a common compartment while other single therapeutic agents (or mixtures) are stored in one or more separate compartments. The medicament layer 46 can be applied to the second major surface 52 of at least one electrode 44 (e.g., an interdigitated electrode) by an elongated tube. The tube may have a first end and an opposing second end. The first end and an opposing second end of the tube are connected to the medicament layer 46 and the drug reservoir portion of the device, respectively. The release characteristics of the respective compartments can be adjusted according to specific applications of the present invention.

The drug reservoir portion of the device may include an elongated tube. The tube may have a first end and an opposing second end. An interior of the tube may define a reservoir, and a drug formulation core may be housed in the reservoir. The drug formulation may be in a substantially solid form, such as a drug rod, although other configurations are possible. The tube may have one or more apertures for dispensing the drug, such as via osmosis, diffusion, or a combination thereof among others. In embodiments, the release rate of the drug from the drug reservoir portion may be controlled. For example, a degradable membrane may be disposed over or in one or more of the apertures to control the initiation of release of the drug formulation from the reservoir. As another example, a sheath may be positioned over a portion of the tube to reduce the release rate, such as by reducing the osmotic surface area of the tube or by reducing diffusion through the tube wall. Also, the drug reservoir portion may be formed from a drug polymer composite designed to release at a known rate.

In a preferred embodiment, the drug reservoir portion operates as an osmotic pump. Solubilized drug is dispensed at a controlled rate out of the reservoir through the one or more apertures, driven by osmotic pressure in the reservoir. The delivery rate is affected by the surface area of the tube, the thickness of the tube wall, the permeability to liquid of the material used to form the tube, and the shape, size, number and placement of the apertures, among others. The delivery rate can be predicted from the physicochemical parameters defining the particular drug delivery system, according to well known principles, which are described for example in Theeuwes, J. Pharm. Sci., 64(12):1987-91 (1975).

The present invention is further illustrated by the following example, which is not intended to limit the scope of potential applications of the present invention.

### EXAMPLE

Background

MACROESIS™ drug delivery system uses an AC electrical field to push active pharmaceutical agents through biological membranes, such as peroxide gels into the layers of tooth enamel. Current methods of chair-side whitening involve applying a gel which is either self-activating, or activated by heat or UV. Another alternative involves custom trays containing the whitening agent obtained from a dentist used over a 7-10 day period at home (30 min to 2 hours per application). An in vitro model of drug delivery was used in a validity study investigating the delivery of a 35% Carbamide Peroxide gel into extracted human teeth by MACROESIS™.

Methods

Fourteen (14) freshly extracted human teeth without detectable caries or restoration were stored in distilled water at 4° C. and used within 1 month of extraction. Teeth were randomly assigned to the diffusion experimental group (6 teeth) or enhanced electrochemical delivery (MACROESIS™) experimental group (6 teeth). Two teeth were randomly assigned to a control group. The experiment was run in two rounds of six teeth each (3 from each treatment group) approximately two weeks apart to show repeatability of results.

The diffusion group received: 66±1 mg 6% HP gel applied evenly to the tooth surface for 20 minutes. The MACROESIS™ group received: 66±1 mg 6% HP gel applied evenly to the tooth surface for 20 minutes using the electrochemical drug delivery device and electrode (FIG. 5A-C). The control group contained one control tooth subjected to the diffusion treatment and one control tooth subjected to the MACROESIS™ treatment.

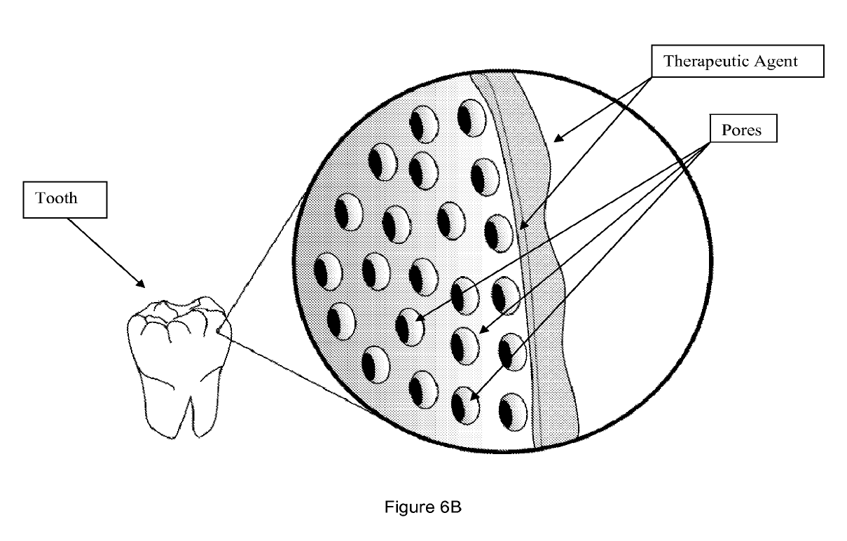

Following treatment, the teeth were rinsed twice in distilled water and dried. The outer surface of the teeth was covered with two layers of clear nail varnish to fill any defects. A circular class V cavity measuring 2 mm deep (FIG. 7) was created above the cementum-enamel junction by drill press using a 1/16″ diamond drill bit. No cavity was created in the two control teeth.

The teeth were placed in 50 mL beakers containing 3 mL distilled water with class V cavities below the water level to allow diffusion from the cavity to the water acting as a receiving medium. The total of the receiving medium was removed at 1 hour (2 mL), 24 hours and 48 hours (3 mL), and immediately replaced.

The amount of H₂O₂ that diffused from the dentin was measured by a colorimetric oxidation-reduction reaction kit (HYDROGEN PEROXIDE CHEMets®, VACUettes® and Vacu-vials®, CHEMetrics, Inc., Calverton, Va.). HP concentration was measured by UV-Vis spectroscopy at 550 nm.

Results

The receiving medium (distilled water) was removed for analysis and replaced at 1 hour, 24 hours and 48 hours. The majority of the HP eluted from the teeth into the water between 1 hour and 24 hours and was captured in the 24-hour samples. The 1-hour and 48-hour samples contained HP concentrations below the threshold of reliable detection (0.1 PPM) and were excluded from analysis.

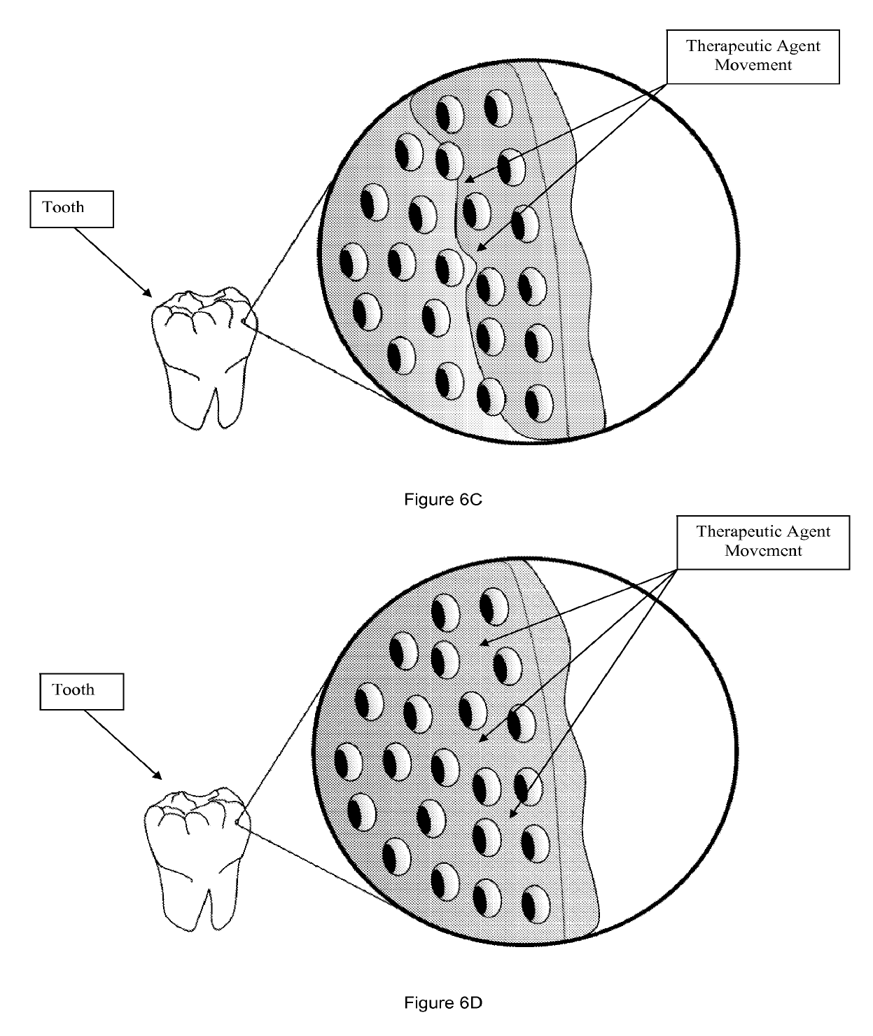

The analysis found significant between group differences were found with relative percent errors of 3 percent or less (a single outlier had an RPE of 12 percent). A summary of data from the first round of studies is presented in FIG. 8.

FIG. 9 shows the average absorbance for the MACROESIS™ group was 79 percent greater than the diffusion group. FIG. 10 shows a dot diagram of the range of points for both groups, with the MACROESIS™ group trending toward higher absorbances than the diffusion group.

A single-factor ANOVA found a statistically significant difference between the diffusion and MACROESIS™ groups with 99 percent confidence. The second round of studies confirmed the findings from the first round, finding a 130 percent improvement in MACROESIS delivery over diffusion with relative percent errors of measurement 5 percent or less except for a single outlier at 10 percent. A single-factor ANOVA again found a statistically significant difference between the diffusion and MACROESIS™ groups with 99 percent confidence. FIG. 11 summarizes the results from both rounds of studies.

From the above description of the invention, those skilled in the art will perceive improvements, changes and modifications. Such improvements, changes, and modifications are within the skill of the art and are intended to be covered by the appended claims.

Having described the invention, we claim:

1. An apparatus for delivering at least one therapeutic agent to a dental tissue of a subject, said apparatus comprising:
at least one electrode having oppositely disposed, first and second electrically-conductive major surfaces, said first major surface being shaped such that said first major surface substantially conforms to the contour of the dental tissue when said first major surface is in contact with the dental tissue;
a medicament layer including said at least one therapeutic agent, said medicament layer being disposed on at least a portion of said second major surface;
an electrical signal source for providing a signal having certain characteristics, said electrical signal source being electrically connected to said at least one electrode; and
logic configured to control said electrical signal source;
wherein said certain characteristics of said electrical signal source comprises at least one orienting frequency and at least one motivating frequency sufficient to motivate said at least one therapeutic agent into the dental tissue.

2. The apparatus of claim 1, wherein each of said at least one orienting frequency and said at least one motivating frequency comprises an alternating current (AC) signal.

3. The apparatus of claim 1, wherein said at least one orienting frequency comprises an AC signal and said at least one motivating frequency comprises a direct current (DC) signal.

4. The apparatus of claim 1, wherein said at least one electrode is an interdigitated electrode.

5. The apparatus of claim 1, wherein said first major surface of said at least one electrode is curved such that said first major surface is substantially similar to the radius of curvature of a human mouth.

6. The apparatus of claim 1, wherein said the dental tissue is a cheek, a lip, a tongue, a buccal, a lingual, a gingiva, or a soft palette of a mouth.

7. A system for delivering at least one therapeutic agent to a dental tissue of a subject, said system comprising:
an apparatus including:
at least one electrode having oppositely disposed, first and second electrically-conductive major surfaces, said first major surface being shaped such that said first major surface substantially conforms to the contour of the dental tissue when said first major surface is in direct contact with the dental tissue;
a medicament layer including said at least one therapeutic agent, said medicament layer being disposed on at least a portion of said second major surface;
an electrical signal source for providing a signal having certain characteristics, said electrical signal source being electrically connected to said at least one electrode; and
logic configured to control said electrical signal source;
wherein said certain characteristics of said electrical signal source comprises at least one orienting frequency and at least one motivating frequency sufficient to motivate said at least one therapeutic agent into the dental tissue;
an electrical lead having oppositely disposed proximal and distal ends, said proximal end being electrically connected to said electrical signal source and said distal end being electrically connected to said at least one electrode, said electrical lead for delivering said electrical signal to said at least one electrode.

8. A method for delivering at least one therapeutic agent to a dental tissue of a subject, said method comprising the steps of:
providing an apparatus comprising at least one electrode, a medicament layer including said at least one therapeutic agent, an electrical signal source, and logic configured to control the electrical signal source, said at least one electrode having oppositely disposed first and second major surfaces, the medicament layer being disposed on at least a portion of the second major surface, the electrical signal source being electrically connected to said at least one electrode;
placing at least one portion of the first major surface into contact with the dental tissue so that said at least one portion substantially conforms to the contour of the dental tissue; and
causing the electrical signal source to provide a signal having certain characteristics to motivate said at least one therapeutic agent into the dental tissue.

9. The method of claim 8, wherein said step of causing the electrical signal source to provide a signal further comprises the steps of:
selecting at least one orienting frequency; and
selecting at least one motivating frequency.

10. The method of claim 9, wherein each of said at least one orienting frequency and said at least one motivating frequency comprises an AC signal.

11. The method of claim 9, wherein said at least one orienting frequency comprises an AC signal and said at least one motivating frequency comprises a DC signal.

12. The method of claim 8, wherein said step of placing at least a portion of the first major surface into contact with the dental tissue further comprises the step of positioning the first major surface substantially adjacent to a dental tissue selected from the group consisting of a cheek, a lip, a tongue, a buccal, a lingual, a gingiva, or a soft palette of a mouth.

13. The method of claim 8, wherein said step of placing at least a portion of the first major surface into contact with the dental tissue further comprises the step of positioning the first major surface substantially adjacent to or under a cheek, a lip, a tongue, a buccal, a lingual, a gingiva, or a soft palette of a mouth.

14. A method for delivering at least one therapeutic agent to a select region of a subject's mouth or dental tissue, said method comprising the steps of:
providing an apparatus comprising at least one electrode, a medicament layer including said at least one therapeutic agent, an electrical signal source, and logic configured to control the electrical signal source, said at least one electrode having oppositely disposed, electrically-conductive first and second major surfaces, the medicament layer being disposed on at least a portion of the second major surface, the electrical signal source being electrically connected to said at least one electrode;
shaping at least one of the medicament layer and said at least one electrode so that delivery of the electrical signal to said at least one electrode motivates said at least one therapeutic agent into the select region of the subject's mouth or dental tissue; and
causing the electrical signal source to provide an electrical signal to said at least one electrode to motivate said at least one therapeutic agent into the select region of the subject's mouth or dental tissue.

15. The method of claim 14, wherein the select region of the subject's mouth or dental tissue is a cheek, a lip, a tongue, a buccal, a lingual, a gingiva, or a soft palette of a mouth.

16. The method of claim 15, wherein said step of shaping at least one of the medicament layer and said at least one electrode further comprises the step of centering the medicament layer on the second major surface of said at least one electrode so that the medicament layer is substantially adjacent at least a portion of the a cheek, a lip, a tongue, a buccal, a lingual, a gingiva, or a soft palette of a mouth.

17. The method of claim 14, wherein said step of shaping at least one of the medicament layer and said at least one electrode further comprises the step of centering the medicament layer on the second major surface of said at least one electrode so that the medicament layer is substantially adjacent at least a portion of a cheek, a lip, a tongue, a buccal, a lingual, a gingiva, or a soft palette of a mouth.
